(19) United States
(12) Patent Application Publication
(10) Pub. No.: US 2019/0165340 A1
(43) Pub. Date: May 30, 2019

(54) SYSTEM AND METHOD FOR SECURING BONDED POUCH CELLS

(71) Applicant: Nova Lumos Ltd., Netanya (IL)

(72) Inventors: Nir NITZANI, Kefar Sava (IL); David VORTMAN, Tzur Moshe (IL); Nir MAROM, Tzur Moshe (IL)

(73) Assignee: Nova Lumos Ltd., Netanya (IL)

(21) Appl. No.: 15/934,218

(22) Filed: Mar. 23, 2018

Related U.S. Application Data
(60) Provisional application No. 62/592,512, filed on Nov. 30, 2017.

(51) Int. Cl. H01M 2/04; H01M 10/42; H01M 2/10; H01M 2/02

(52) U.S. Cl. CPC H01M 2/0408; H01M 10/425; H01M 2010/4271; H01M 2/026; H01M 2/1061

(57) ABSTRACT

An energy storage device. The energy storage device includes a first pouch battery including a first terminal, a first pouch, and a first cell disposed in the first pouch; a second pouch battery positioned beneath the first pouch battery, the second pouch battery including a second terminal, a second pouch, and a second cell disposed in the second pouch; and a battery management system (BMS) positioned between the first cell and the second cell, wherein the BMS is coupled to the first terminal and to the second terminal; wherein each pouch has a top foil and a bottom foil, each foil including a first edge, a second edge, a third edge, and a fourth edge; wherein each edge of the bottom foil of the first pouch is bonded to a corresponding edge of the top foil of the second pouch.

### CROSS-REFERENCE TO RELATED APPLICATIONS

This application claims the benefit of U.S. Provisional Application No. 62/592,512 filed on Nov. 30, 2017, the contents of which are hereby incorporated by reference.

### TECHNICAL FIELD

The present disclosure relates generally to rechargeable batteries, and in particular to pouch batteries.

### BACKGROUND

With modern advances in electronics technology, battery life has become increasingly important. As a result, batteries that are simple, flexible, and lightweight have become highly desirable. Batteries including cells disposed in pouches (“pouch batteries”) provide high packaging efficiencies that allow designers and engineers to create devices which are not limited by the form factor of the energy element of the electronic device. A pouch cell typically includes conductive foil tabs welded to electrodes, thereby allowing for electrical connections outside of the pouch for transferring electricity while the battery remains fully sealed. The pouch provides a soft pack that allows for reducing weight of the battery.

As pouch batteries are useful and relatively expensive, there is a market for repurposing such batteries, for example by attempting to bypass battery management systems and accessing the cells directly. Thus, pouch batteries are frequent targets of tampering attempts.

It would therefore be advantageous to provide a battery system which would be resistant, if not impervious, to at least some of these repurposing techniques.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a secure energy storage device. The secure energy storage device comprises: a first pouch battery including a first terminal, a first pouch, and a first cell disposed in the first pouch; a second pouch battery positioned beneath the first pouch battery, the second pouch battery including a second terminal, a second pouch, and a second cell disposed in the second pouch; and a battery management system (BMS) positioned between the first cell and the second cell, wherein the BMS is coupled to the first terminal and to the second terminal; wherein each pouch has a top foil and a bottom foil, each foil including a first edge, a second edge, a third edge, and a fourth edge; wherein the first edge of the bottom foil of the first pouch is bonded to the first edge of the top foil of the second pouch, the second edge of the bottom foil of the first pouch is bonded to the second edge of the top foil of the second pouch, the third edge of the bottom foil of the first pouch is bonded to the third edge of the top foil of the second pouch, and the fourth edge of the bottom foil of the first pouch is bonded to the fourth edge of the top foil of the second pouch.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a cross-sectional view of a secured pouch battery utilized according to an embodiment.

FIG. 1B is a cross-sectional view of a secured pouch battery utilized according to another embodiment.

FIG. 2 is a cross-sectional view of a secure energy storage device according to an embodiment.

FIG. 3 is a cross-sectional view of a secure energy storage device with a battery management system according to an embodiment.

FIG. 4 is a schematic illustration of a top-frontal isometric view of a secure energy storage device according to an embodiment.

FIG. 5 is a cross-sectional view of a secure energy storage device according to yet another embodiment.

FIG. 6 is a schematic illustration of a top-frontal isometric view of a secure energy storage device according to another embodiment.

FIG. 7 is a schematic illustration of a top-frontal isometric view of a secure energy storage device according to yet another embodiment.

FIG. 8 is cross-sectional view of a secured pouch battery with a battery management system and an outgoing terminal according to an embodiment.

FIG. 9 is an example schematic diagram of a battery management system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a secure energy storage device. In an embodiment, the secure energy storage device includes a first pouch battery, a second pouch battery positioned beneath the first pouch battery, and a battery management system (BMS). The first pouch battery further comprises a first terminal, a first pouch, and a first cell disposed in the first pouch. The second pouch battery further comprises a second terminal, a second pouch, and a second cell disposed in the second pouch. The BMS is positioned between at least the first cell and the second cell. The BMS is coupled to the first terminal of the first battery and to the second terminal of the second battery.

Each pouch includes a top foil and a bottom foil, where a first edge of the bottom foil and a first edge of the top foil are bonded together, a second edge of the bottom foil and a second edge of the top foil are bonded together, a third edge of the bottom foil and a third edge of the top foil are bonded together, and a fourth edge of the bottom foil and a fourth edge of the top foil are bonded together. The top foil of the second pouch is bonded to the bottom foil of the first pouch.

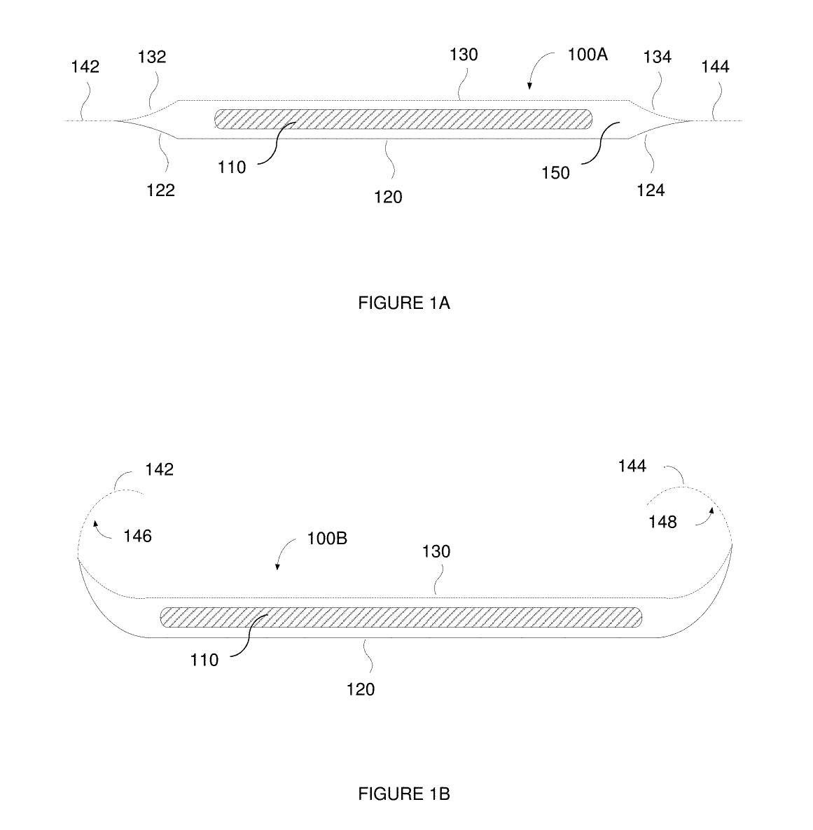

FIG. 1A is an example cross-sectional view of a bonded secured pouch battery 100A utilized according to an embodiment. The pouch battery 100 includes a cell 110 disposed in a cavity 150 between a bottom foil 120 and a top foil 130. Each foil 120 or 130 may be, but is not limited to, a polymer laminate.

In an embodiment, the top foil 130 and the bottom foil 120 are bonded together, for example by using an adhesive. To this end, the bottom foil 120 includes first and second excess portions 122 and 124, respectively, and the top foil 130 includes first and second excess portions 132 and 134, respectively. This results in a pouch structure with the cavity 150 in which the cell 110, for example a rechargeable cell, may be disposed and protected from external elements. The rechargeable cell may be, but is not limited to, a Lithium-ion (Li-ion) cell, a Lithium polymer (LIPo) cell, and the like.

Each excess portion extends from the respective foil 120 or 130 and includes an edge of the foil 120 or 130. The excess portion of one foil 120 or 130 may be bonded to a corresponding excess portion of the other foil 120 or 130 (e.g., by bonding at least the edge of the excess portion of one foil to the edge of the corresponding excess portion of the other foil), thereby collectively bonding the top foil 130 to the bottom foil 120. Specifically, the first top excess portion 132 is bonded with the first bottom excess portion 122, resulting in a first bonded sheet 142. The second top excess portion 134 is bonded with the second bottom excess portion 124, resulting in a second bonded sheet 144. A third and a fourth bonding may each be performed perpendicular to the first and second bonded sheets 142 and 144 such that bonded sheets (not shown in FIGS. 1A-1B) formed by the third and fourth bondings are parallel to each other, and the first and second bonded sheets 142 and 144 are similarly parallel to each other.

FIG. 1B is an example cross-sectional view of a bonded secured pouch battery 100B utilized according to another embodiment. The first bonded sheet 142 and the second bonded sheet 144 may each be rolled, for example onto themselves. In some embodiments, an adhesive or other bonding agent may be deposited on the top portion 146 of the first bonded sheet 142 and on a top portion 148 of the second bonded sheet 144 to cause bonding as each bonded sheet 142 or 144 is rolled (or, in some embodiments, folded), thereby preventing the bonded sheet 142 or 144 from unraveling during storage, normal use, or both.

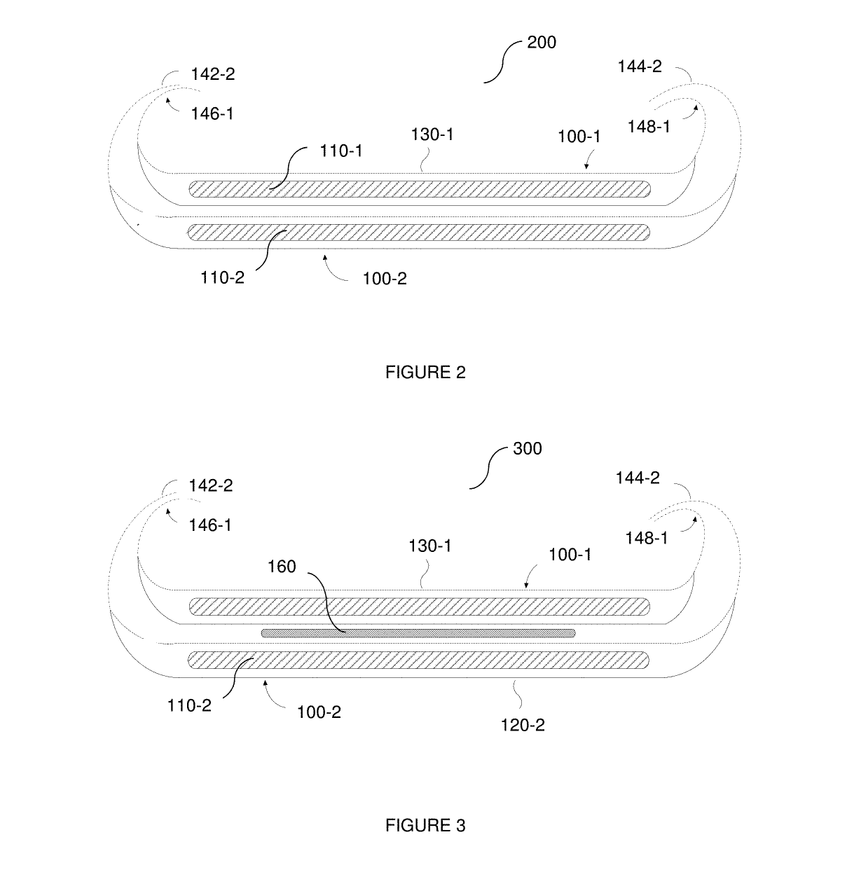

FIG. 2 is an example cross-sectional view of a secure energy storage device 200 according to an embodiment. The secure energy storage device 200 includes a first pouch battery 100-1 and a second pouch battery 100-2. The second pouch battery 100-2 is positioned beneath the first pouch battery 100-1. In the example implementation shown in FIG. 2, each pouch battery 100-1 or 100-2 is as described herein with respect to FIG. 1B.

In an embodiment, the top foil 130 and the bottom foil 120 of each pouch battery 100-1 or 100-2 may each include a third excess portion and a fourth excess portion (not shown in FIG. 2), each excess portion corresponding to a side of a rectangular shape of the foil, such that the third excess portion of the top foil 130 corresponds to a third excess portion of the respective bottom foil 120 and the fourth excess portion of the top foil 130 corresponds to a fourth excess portion of the respective bottom foil 120. In an example implementation, the excess portions may resemble a substantially cross-shaped foil.

The bonded sheets 142 and 144 of the pouch batteries 100-1 and 100-2 may be rolled together such that the top portion 148-1 of the bonded sheet 144-1 of the first pouch battery 100-1 is beneath the top portion 148-2 of the second bonded sheet 144-2 of the second pouch battery 100-2 (the bonded sheets 142-1 and 142-2 may be collectively referred to as bonded sheets 142 and the bonded sheets 144-1 and 144-2 may be collectively referred to as bonded sheets 144 merely for simplicity purposes).

FIG. 3 is an example cross-sectional view of a secured energy storage device 300 including a battery management system (BMS) 160 according to an embodiment. The BMS 160 is positioned between a first pouch battery 100-1 and a second pouch battery 100-2. In some implementations, more than two pouch batteries may be used, and one or more battery management systems may be placed between any two of the pouch batteries.

The BMS 160 is coupled with terminals including at least an anode (not shown in FIG. 3) of the first pouch battery 100-1 and a cathode (not shown) of the second pouch battery 100-2. The BMS 160 manages the pouch batteries 100-1 and 100-2, and may monitor, for example but not limited to, total voltage, voltage of each cell, temperature, state of charge, depth of charge, current, and the like. The BMS 160 may further include an over-voltage protection circuit, an under-voltage protection circuit, an over-current protection circuit, an over-discharge protection circuit, and the like. The BMS 160 may further be coupled to a communication bus (not shown) to allow communication between the BMS 160 and a load powered by either or both of the pouch batteries 100-1 and 100-2. An example schematic diagram of the BMS 160 is described further herein below with respect to FIG. 9.

In an example implementation, the BMS 160 may include an authentication module (not shown) for authenticating commands to ensure that only commands received from authorized sources are executed. This may ensure, for example, that the pouch batteries 100-1 and 100-2 only serve one or more intended uses. In some implementations, a protection circuit module (PCM, not shown) may be utilized instead of the BMS 160.

It should be noted that FIGS. 2-3 are described herein with respect to use of pouch batteries 100B of FIG. 1B merely for example purposes, and that the pouch battery 100A of FIG. 1A may be equally utilized without departing from the scope of the disclosure.

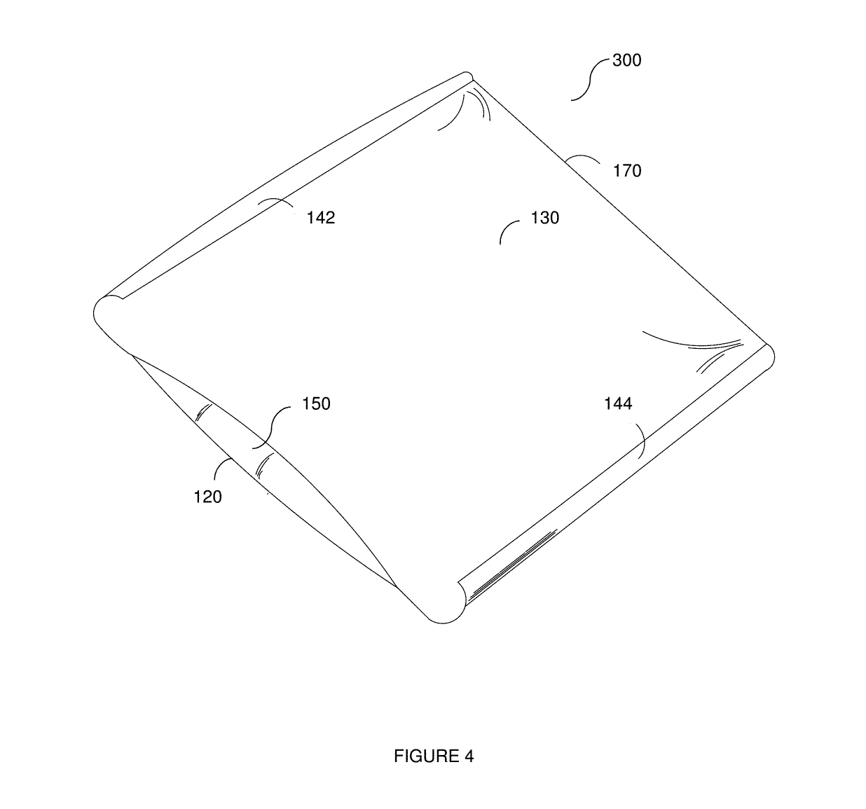

FIG. 4 is an example top-frontal isometric view of the secure energy storage device 300. In this example embodiment, the first bonded sheet 142 and the second bonded sheet 144 are rolled towards the top surface of the top foil 130. A third edge 170 of the top foil 130 is bonded to a third edge (not shown) of the bottom foil 120. In an embodiment, the top foil 130 and bottom foil 120 each include a third excess portion corresponding to the third edge, such that the bonding results in a third bonded sheet. The third bonded sheet may be rolled (rolling of the third bonded sheet not shown in FIG. 4) towards the top surface of the top foil 130, or towards the bottom surface of the bottom foil 120.

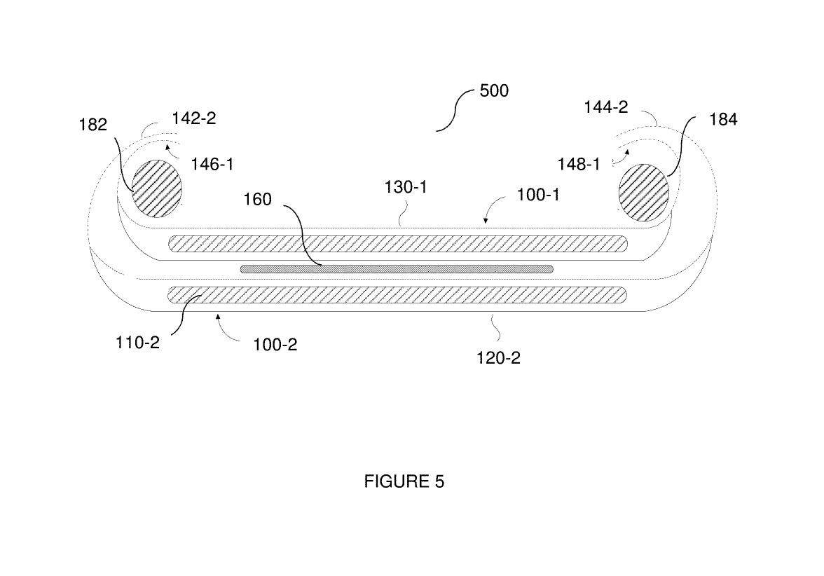

FIG. 5 is an example cross-sectional view of a secure energy storage device 500 according to yet another embodiment. The secure energy storage device 500 includes the components described herein above with respect to FIG. 3 in addition to a first filament 182 and a second filament 184.

The first bonded sheet 142-1 of the first pouch battery 100-1 and the second bonded sheet 144-1 of the first pouch battery 100-1 may each be rolled towards the top surface of the top foil 130-1 of the first pouch battery 100-1. In some embodiments, an adhesive, or other bonding agent, may be placed on the top portion 146-2 of the first bonded sheet 142-1 and on the top portion 148-2 of the second bonded sheet 144-1.

The first filament 182 is positioned such that the first bonded sheet 142-2 of the second pouch battery 100-2 is rolled onto the first bonded sheet 142-1 of the first pouch battery 100-1, which in turn is rolled onto the first filament 182. The second filament 184 is positioned such that the second bonded sheet 144-2 of the second pouch battery 100-2 is rolled onto the first bonded sheet 144-1 of the first pouch battery 100-1, which in turn is rolled onto the second filament 184. In an embodiment, each filament may be cylindrical. In some implementations, each filament may be a hollow or solid rod.

By rolling the bonded sheets 142 and 144 of the pouch batteries 100-1 and 100-2 around the filaments 182 and 184, respectively, the pouches 100-1 and 100-2 are provided with an additional layer of security. For example, accessing the BMS 160 (shown in FIG. 5) in order to manipulate the rechargeable cells 110-1 and 110-2 becomes a difficult task. Specifically, attempts to access either of the rechargeable cells 110-1 or 110-2 requires separating the bonded sheets 142 and 144 of the pouch batteries 100-1 and 100-2 from each other (i.e., separating each bonded sheet 142 or 144 from the corresponding bonded sheet 142 or 144 of the other pouch 100-1 or 100-2) and from the respective filaments 182 and 184. Separation of the bonded sheets 142 and 144 from each other or from the filaments 182 and 184 (for example, to access the cells 110 directly) may result in tearing of the pouch 100-1, 100-2, or both, thereby resulting in cell degradation. The cell degradation may be severe, particularly when the cells then come into contact with moisture.

In the example embodiment shown in FIG. 5, the first bonded sheet 142-1 and the second bonded sheet 144-1 are rolled towards the top foil 130-1. In another embodiment, the first bonded sheet 142-1, the second bonded sheet 144-1, or both, may be rolled towards the bottom foil 120-2. In such an embodiment, the filaments are positioned accordingly.

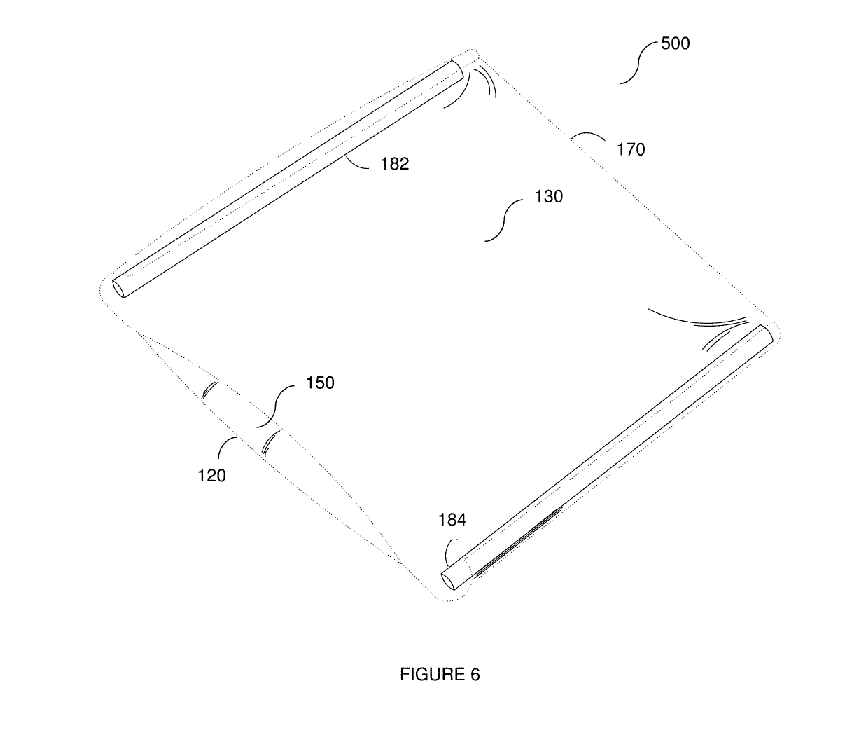

FIG. 6 is a top-frontal isometric view of the secure energy storage device 500. The BMS 160 is secured between two rechargeable cells 112 and 114. Typically, in order to repurpose a rechargeable cell, access is required to an anode and a cathode of the rechargeable cell. If a plurality of rechargeable cells are to be repurposed, then access is required to at least an anode of a first rechargeable cell, and at least a cathode of a second rechargeable cell, assuming the cathode of the first rechargeable cell is connected to the anode of the second rechargeable cell. A plurality greater than two rechargeable cells may of course be implemented. In some of the embodiments discussed herein, an anode and a cathode of one or more rechargeable cells are connected to a BMS (e.g., the BMS 160, FIG. 5). The BMS includes at least two terminals protruding from the pouch. The terminals are operative to connect batteries (e.g., the pouch batteries 100-1 and 100-2) to a load.

It should be noted that components of FIG. 6 other than the filaments 182 and 184 are shown in broken lines merely for illustrative purposes and without limitation on the disclosed embodiments. The broken lines are utilized to demonstrate an example positioning of the filaments 182 and 184 unobscured by the bonded sheets 142 and 144.

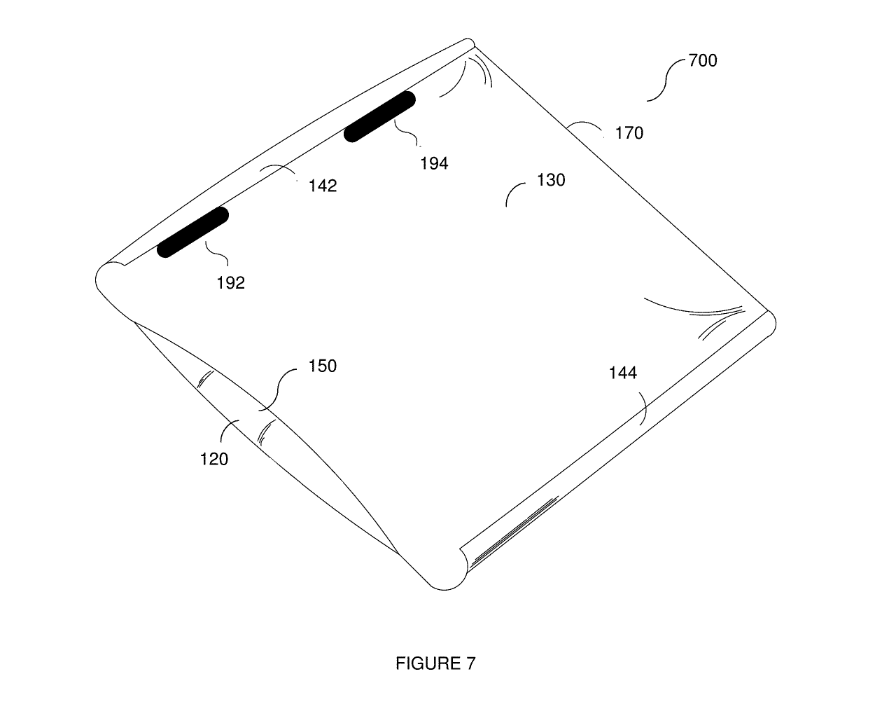

FIG. 7 is a top-frontal isometric view of a secure energy storage device 700 according to yet another embodiment. A first terminal cathode 192 and a second terminal anode 194 protrude from the first bonded sheet 142 such that a BMS (not shown in FIG. 7) may be coupled with an external load, power source, or both, to charge the rechargeable cells of the battery (not shown in FIG. 7) disposed in the secure energy storage device 700 and managed by the BMS.

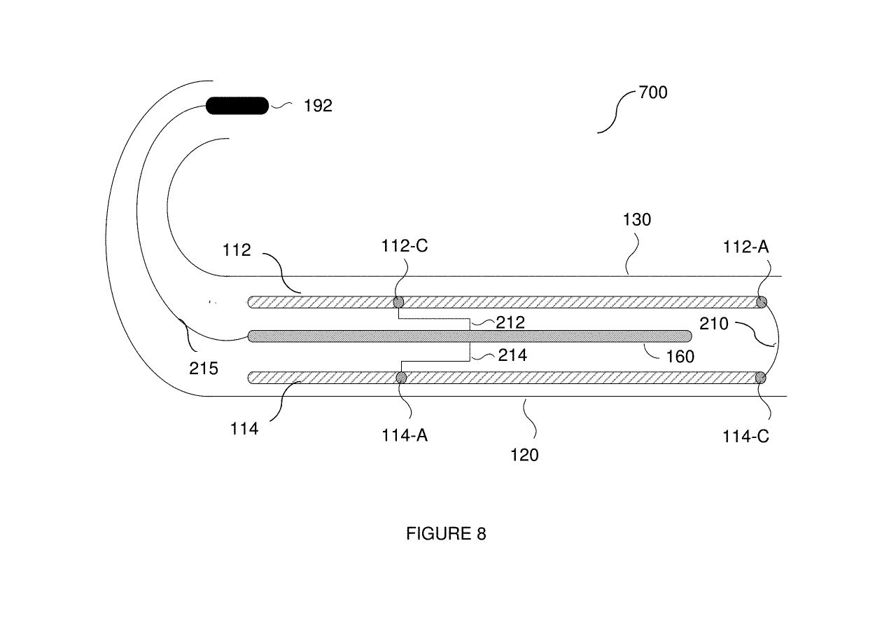

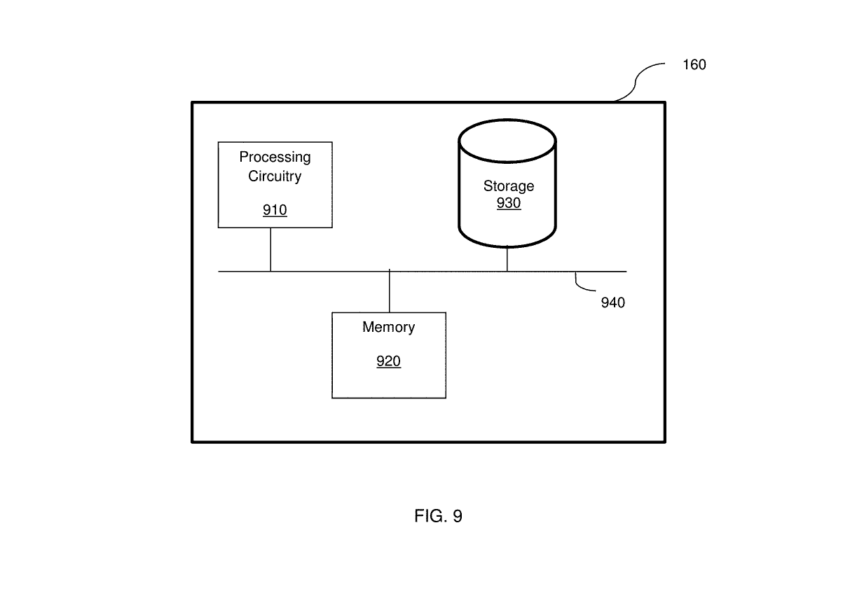

FIG. 8 is a front cross-sectional view of the secure energy storage device 700 including a BMS and an outgoing terminal according to yet another embodiment. In the example implementation shown in FIG. 8, the BMS 160 is placed between the top foil 130 and the bottom foil 120. In some embodiments, the BMS 160 may be further placed between a first rechargeable cell 112 and a second rechargeable cell 114. In an embodiment (not shown), only a single rechargeable cell (e.g. either the first rechargeable cell 112 or the second rechargeable cell 114) is placed between the top foil 130 and the bottom foil 120. The BMS 160 may be coated with an insulated material to protect a circuit (not shown in FIG. 8) of the BMS 160 from the rechargeable cells 112 and 114.

In the example implementation shown in FIG. 8, an anode 112-A of the rechargeable cell 112 is connected (for example via a wire 210) to a cathode 114-C of the rechargeable cell 114. An anode 114-A of the rechargeable cell 114 is connected to the BMS 160 (for example via a wire 214), and a cathode 112-C of the rechargeable cell 112 is connected to the BMS 160 (for example via a wire 212). A wire 215 may connect a terminal (not shown) of the BMS 160 to the terminal 192, which protrudes from the pouch. In a similar fashion, another terminal (not shown) of the BMS 160 may be connected to the other terminal 194. In some embodiments, three or more pouch batteries may be used, each having its own BMS (or PCM, in another example).

FIG. 9 is an example schematic diagram of the battery management system (BMS) 160 according to an embodiment. The BMS 160 includes a processing circuitry 910 coupled to a memory 920, and a storage 930. In an embodiment, the components of the BMS 160 may be communicatively connected via a bus 940.

The processing circuitry 910 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 920 may be volatile (e.g., RAM, etc.), non-volatile (e.g., ROM, flash memory, etc.), or a combination thereof. The storage 930 may be magnetic storage, optical storage, and the like, and may be realized, for example, as flash memory or other memory technology, CD-ROM, Digital Versatile Disks (DVDs), or any other medium which can be used to store the desired information.

In an embodiment, computer readable instructions to monitor and control battery access as discussed herein may be stored in the storage 930. In another embodiment, the memory 920 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

It should be understood that the embodiments described herein are not limited to the specific architecture illustrated in FIG. 9, and other architectures may be equally used without departing from the scope of the disclosed embodiments.

It should be noted that various embodiments described herein with respect to using a BMS, but that other embodiments including protection circuit modules (PCMs) may be equally utilized without departing from the scope of the disclosure. Specifically, each BMS as described with respect to the disclosed embodiments may be replaced with a PCM.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. An energy storage device, comprising:
a first pouch battery including a first terminal, a first pouch, and a first cell disposed in the first pouch;
a second pouch battery positioned beneath the first pouch battery, the second pouch battery including a second terminal, a second pouch, and a second cell disposed in the second pouch; and
a battery management system (BMS) positioned between the first cell and the second cell, wherein the BMS is coupled to the first terminal and to the second terminal;
wherein each pouch has a top foil and a bottom foil, each foil including a first edge, a second edge, a third edge, and a fourth edge;
wherein the first edge of the bottom foil of the first pouch is bonded to the first edge of the top foil of the second pouch, the second edge of the bottom foil of the first pouch is bonded to the second edge of the top foil of the second pouch, the third edge of the bottom foil of the first pouch is bonded to the third edge of the top foil of the second pouch, and the fourth edge of the bottom foil of the first pouch is bonded to the fourth edge of the top foil of the second pouch.

2. The energy storage device of claim 1, further comprising:
a filament bonded to the first edge of the top foil of the first pouch.

3. The energy storage device of claim 2, wherein the first edge of the top foil of the second pouch is rolled onto the first edge of the bottom foil of the first pouch.

4. The energy storage device of claim 2, wherein the BMS includes a third terminal and a fourth terminal, wherein at least one of the third terminal and the fourth terminal protrudes between the first edge of the bottom foil of the first pouch and the first edge of the top foil of the second pouch.

5. The energy storage device of claim 1, wherein each cell is any of: a lithium-ion cell, and a lithium-polymer cell.

6. The energy storage device of claim 1, wherein the BMS includes a third terminal and a fourth terminal, wherein the third terminal and the fourth terminal are connected to a load.
